(19) United States
(12) Patent Application Publication
(10) Pub. No.: US 2009/0313672 A1
(43) Pub. Date: Dec. 17, 2009

(54) HAND-HELD DATA RECORDER, SYSTEM AND METHOD FOR IN-VIVO SENSING

(76) Inventors: Micha Nisani, Ramot Itzhak (IL); Ido Bettesh, Zichron Ya'akov (IL); Alexander Veinblat, Haifa (IL); Kevin Rubey, Ventura, CA (US)

Correspondence Address: Pearl Cohen Zedek Latzer, LLP, 1500 Broadway, 12th Floor, New York, NY, 10036, US

(21) Appl. No.: 12/306,752

(22) PCT Filed: Jun. 28, 2007
(86) PCT No.: PCT/IL07/00791

§ 371 Date: Dec. 29, 2008

Related U.S. Application Data
(60) Provisional application No. 60/817,096, filed on Jun. 29, 2006.

(51) Int. Cl. H04N 7/173

(52) U.S. Cl. 725/114

(57) ABSTRACT

An in-vivo sensing system including an in-vivo sensing device, a data recorder, a receiver and a work station. The data recorder is maintained in a position adjacent a region of interest being sensed by the in-vivo sensing device. The data recorder receives via a receiving antenna a data signal including sensed data, from the in-vivo sensing device. The data signal may be transmitted from the data recorder to a receiver in real time, or almost real time and downloaded from the receiver to the workstation. Neither the data recorder nor the receiving antenna is affixed or attached to the patient thereby allowing an operator to perform in-vivo sensing on one patient after another in quick succession using the same data recorder.

### FIELD OF THE INVENTION

The present invention relates in general to a unit for receiving data transmitted by an in-vivo sensing device. More specifically, the present invention relates to a method of receiving data by a hand-held data recorder and transmitting the received data.

### BACKGROUND OF THE INVENTION

In-vivo sensing devices for diagnosis of the gastrointestinal (GI) tract of a patient such as, for example, ingestible sensing capsules may wirelessly transmit sensed data, such as imaging data, to an external data recorder. The data recorder may be affixed to the patient by a strap or a belt so that the patient may freely perform normal actions during an observation period that may begin after swallowing of the in-vivo sensing device and may end upon its excretion, or after the capsule battery runs down, or after a predefined time. The data recorder may have radio communication capability and it may have connected to it one or more antennas for receiving the sensed data transmitted by the in-vivo sensing device and the data recorder may have a memory for storing the received sensed data. The receiving antennas may be located in a belt or in a form of clothing that is wrapped around the patient. Alternatively, the receiving antennas may have an adhesive surface so that they may be adhere to the patient's body.

After the observation period, the patient may deliver the data recorder to an operator, for example, a health professional who may be located at a health center and who may download the stored sensed data for processing and for performing analysis of the GI tract for diagnosis purposes. The sensed data may include image data of the GI tract captured by an imager in the in-vivo sensing device as it passes through the GI tract. In some cases, the patient may be unable to get to the health center. In some cases it may be necessary to perform in-vivo sensing on a number of patients in quick succession. It may also only be required to perform the in-vivo sensing on a particular region of the patient's body. For example, it may be required to perform the in-vivo sensing on the esophagus only. In another example, it may be required to perform the in-vivo sensing on the stomach only. Or, it may be required to perform the in-vivo sensing on the esophagus and the stomach. In such circumstances it may be advantageous to save the time required to attach the data recorder in the data recorder belt and to put the belt on the patient. Likewise, it may be advantageous to save the time required affixing the receiving antennas to the patient.

### SUMMARY OF THE INVENTION

In accordance with the present invention, there is provided a unit such as a data recorder for receiving in-vivo sensed data signals transmitted by an in-vivo sensing device. The data recorder may be hand-held. The data recorder comprises a data recorder receiving antenna which may be an internal or external antenna, for receiving the data signals.

According to embodiments of the present invention, a data signal transmitted by the in-vivo sensing device to the hand-held data recorder may be transmitted by the hand-held data recorder to a receiver and then downloaded to a workstation. The data signal may include sensed data such as image data captured by an imager in the in-vivo sensing device. In some embodiments, the receiver may be located in the vicinity of the hand-held data recorder. In some embodiments, the workstation may be located in the vicinity of the hand-held data recorder. In some embodiments, the workstation may be remote from the hand-held data recorder. In some embodiments, both the receiver and the workstation may be remote from the hand-held data recorder.

The hand-held data recorder may receive the data signal from the in-vivo sensing device during an acquisition period. The in-vivo sensing device may traverse the gastrointestinal tract or other body lumens or cavities of a patient and the acquisition period may be the total time that the in-vivo sensing device acquires sensed data of the gastrointestinal tract or other body lumens or cavities of the patient. In some embodiments, only the data signal transmitted by the in-vivo sensing device whilst traversing the esophagus is received by the receiver. In some embodiments, only the data signal transmitted by the in-vivo sensing device whilst traversing the stomach is received by the receiver. In some embodiments, only the data signal transmitted by the in-vivo sensing device whilst traversing the esophagus and the stomach is received by the receiver.

According to some embodiments, in-vivo sensing of a region of interest of the patient is performed by an operator, for example, a health professional. Typically, the operator may hold the hand-held data recorder. The patient swallows the in-vivo sensing device and the operator may hold the hand-held data recorder adjacent the region of interest. In other embodiments, the hand-held data recorder need not be physically held by the operator. The hand-held data recorder may be maintained in a position adjacent the region of interest. For example, the data recorder may be placed on a cord or a string around the patient's neck, or may be held by the patient. In some embodiments, the data recorder may be worn on the patient's wrist, or placed in a cradle beside the patient's chair or bed. As the in-vivo sensing device traverses the region of interest, the data signal transmitted by it is received by the hand-held data recorder. The hand-held data recorder may comprise a temporary storage unit for storing the received data. The operator may move the hand-held data recorder over the patient's body in order to maintain its position adjacent to the in-vivo sensing device as the latter traverses the region of interest. The hand-held data recorder may comprise a transmitting antenna connected to a radio transmitter. The hand-held data recorder may comprise a USB interface and a USB connector. The stored data may be transmitted to a receiver and then downloaded to a workstation. The stored data may be transmitted wirelessly or by cable to the receiver.

By using the hand-held data recorder of the present invention, in which the data recorder is not fixed to the patient and/or in which the receiving antenna is not affixed or attached to the patient, the operator may perform in-vivo sensing on one patient after another in quick succession using the same data recorder.

The hand-held data recorder may include a data recorder display unit having a liquid crystal (LCD) display. In accordance with some embodiments, the display may show in real time images captured by the imager of the in-vivo sensing device.

In accordance with some embodiments the in-vivo sensing device may be remotely controllable by the hand-held data recorder. In accordance with such embodiments, the real time images captured by the imager and displayed on the data recorder display may assist an operator in navigating the in-vivo sensing device as it traverses the gastrointestinal tract or other body lumens or cavities of the patient.

In accordance with those embodiments in which the data received by the hand-held data recorder is transmitted wirelessly to the receiver, batches of the data may be transmitted from the hand-held data recorder to the receiver, as soon as, or soon after, a batch of data has been received by the data recorder. The batches of data received by the receiver may be downloaded to the workstation as soon as, or soon after, each batch is received by the receiver. In this manner, the data may be transmitted from the hand-held data recorder to the receiver in real time, in almost real time, that is, in quasi real time, or given periods of time, depending on the size of a batch. In some embodiments, the receiver and the workstation may be integrated into a single unit.

The in-vivo sensing device may include at least one sensor such as an imager for capturing image data in the form of image frames of images. In some embodiments, the imager may capture image data at a rate of, for example, two frames per second. If the image frames captured by the imager and transmitted by the in-vivo sensing device to the hand-held data recorder are transmitted to the receiver at the same rate as the rate of capture, then the data signal received by the hand-held data recorder may be transmitted to the receiver in real time. In accordance with some embodiments, the image frames received by the hand-held data recorder may be temporarily stored for a given time period before being transmitted to the receiver. For example, the image frames received by the hand-held data recorder may be temporarily stored for one minute, thereby storing 120 frames, before being transmitted to the receiver.

Transmitting the data signal from the hand-held data recorder to the receiver in real time, or, in almost real time, ensures that at the end of the acquisition period, when in-vivo sensing of the region of interest of the patient has been completed, the hand-held data recorder is ready for use again for in-vivo sensing of the region of interest of another patient. If larger periods of time, for example, five or ten minutes, or more, are used as the periods of time for transmitting the received data signal from the hand-held data recorder to the receiver, then that hand-held data recorder may be provided with a press-button for depressing in order to cause any stored data left in the data recorder at the end of the acquisition period to be transmitted to the receiver.

### BRIEF DESCRIPTION OF THE DRAWINGS

The present invention will be understood and appreciated more fully from the following detailed description taken in conjunction with the drawings in which:

FIG. 1 is a simplified conceptual illustration of a system for transmitting data received from an in-vivo sensing device according to embodiments of the present invention;

FIG. 2 is an illustrative block diagram showing components of a hand-held data recorder in accordance with some embodiments of the present invention; and

FIG. 3 is a flow chart showing the procedure for in-vivo sensing of a number of patients in succession, according to some embodiments of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

The device, system and method of the present invention may be used with an imaging system or device such as that described in U.S. Pat. No. 5,604,531 entitled “In Vivo Video Camera System,” which is incorporated herein by reference. A further example of an imaging system and device with which the system and method of the present invention may be used is described in U.S. Pat. No. 7,009,634 entitled “Device for In Vivo Imaging,” which is incorporated herein by reference. For example, a swallowable imaging capsule such as that described in U.S. Pat. No. 7,009,634, may be used in the present invention.

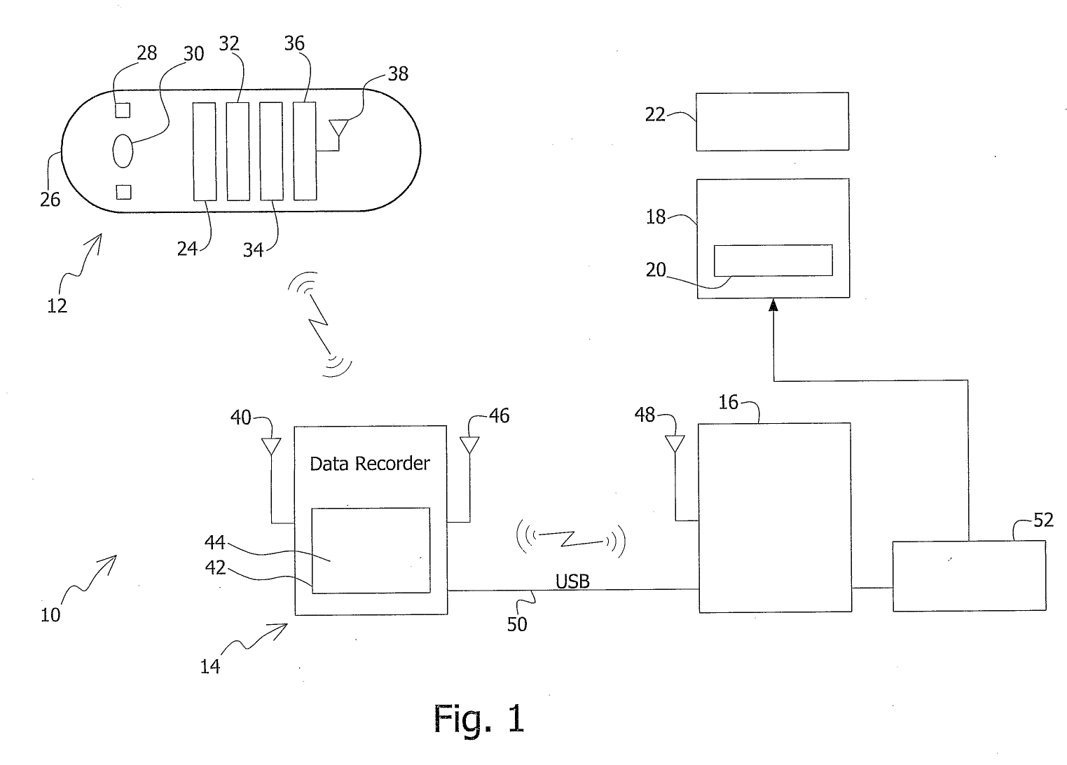

Reference is made to FIG. 1, showing in-vivo sensing system 10 according to embodiments of the present invention. The in-vivo sensing system 10 includes an in-vivo sensing device 12, a hand-held data recorder 14, an optional additional, possibly remote, receiver 16 and a work station 18 having a work station processor 20 and a display unit 22. In some embodiments, the receiver 16 and the work station 18 may be integrated into a single unit, for example, may be integrated into a single portable unit.

In some embodiments, the in-vivo sensing device 12 may be a wireless device. In some embodiment, the in-vivo sensing device 12 may be autonomous. In other embodiments, the in-vivo sensing device 12 may be controlled by an external controller or receive control information, either when the device is not in the body, before the procedure, or during the procedure while the device is in vivo. In some embodiments, the in-vivo sensing device 12 may be a swallowable capsule for sensing the gastrointestinal tract of a patient. However, other body lumens or cavities may be sensed or examined with the in-vivo sensing device 12.

The in-vivo sensing device 12 may include at least one sensor such as an imager 24 for capturing image data in the form of image frames of images of the gastrointestinal tract or other body lumens or cavities, a viewing window 26, one or more illumination sources 28, an optical system 30, a power supply such as a capsule battery 32, a capsule processor 34, a capsule transceiver 36, and a capsule antenna unit 38 connected to the capsule transceiver 36. The capsule antenna unit 38 may include several antennas, such as a receiving antenna and a transmitting antenna. These antennas may receive and/or transmit simultaneously, and may use the same or different frequencies. The imager 24 may be and/or contain a CMOS imager. Alternatively, other imagers may be used, e.g. a CCD imager or other imagers. As the in-vivo sensing device 12 traverses the gastrointestinal tract or other body lumens, it takes images thereof at a rate of a given number of frames per second and over a given acquisition period. The series of images captured by the imager 24 of the in-vivo sensing device 12 form frames of a video movie.

The image data and/or other data, captured by the in-vivo sensing device 12 during the acquisition period may be transmitted as a data signal by wireless connection, e.g. by wireless communication channel, from the in-vivo sensing device 12 and received by the hand-held data recorder 14 via a data recorder receiving antenna 40. The data recorder receiving antenna 40 may be located externally or internally with respect to the hand-held data recorder 14. In one embodiment, the data recorder receiving antenna 40 is an internal antenna contained in the hand-held data recorder 14 and not adapted to connect directly to a human body. The hand-held data recorder 14 may include a data recorder display unit 42 having a liquid crystal (LCD) display 44.

In some embodiments, the in-vivo sensing device 12 may receive data from the hand-held data recorder 14 or from a workstation. In some embodiments, the received data may include parameters of the operation of the in-vivo sensing device, for example imager capture frame rate parameters, illumination parameters, delayed operation parameters, capsule repositioning parameters, etc. The data signal received by the in-vivo sensing device 12 may be transmitted from the hand-held data recorder 14 to a receiver located in the in-vivo sensing device, for example to the capsule transceiver 36. The data signal received by the in-vivo sensing device may be transmitted from the data recorder by wireless connection via a data recorder transmitting antenna unit 46, e.g. by wireless communication channel and received at the in-vivo sensing device 12 by the capsule antenna unit 38.

The data signal received by the hand-held data recorder 14 may be transmitted from the hand-held data recorder 14 to the receiver 16. In some embodiments, the receiver 16 may be located at a remote location relative to the hand-held data recorder 14 and in other embodiments receiver 16 may be located in the vicinity of the hand-held data recorder 14. In some embodiments, the data signal received by the hand-held data recorder 14 may be transmitted to the receiver 16 by wireless connection via a data recorder transmitting antenna unit 46, e.g. by wireless communication channel and received at the receiver 16 by a receiver receiving antenna 48. Transmitting antenna unit 46 may include a plurality of antennas, for example an antenna to transmit data to receiver 16 and another antenna to transmit data to the in vivo sensing device 12. The antennas may work simultaneously, for example by using different frequencies for transmission in each one of the antennas.

Wireless transmission may be, for example, by any one of the following technologies: cellular transmission, WLAN (Wireless Local Area Network) transmission, BT (BlueTooth) transmission and Wimax (Worldwide interoperability for Microwave Access) transmission. The receiver 16 may be a receiver capable of operating in accordance with the aforementioned technologies. In some embodiments, the data signal received by the hand-held data recorder 14 may be transmitted to the receiver 16 via a cable 50 using a USB connection.

The data signal received by the receiver 16 may be downloaded to the work station 18 for processing by the work station processor 20 for analysis, and display, for example by the display unit 22. The data signal may be downloaded from the receiver 16 to the work station 18, for example, by telephone via a land telephone line, or via an internet connection between the receiver 16 and the hand-held data recorder 14. The link used for downloading from the receiver 16 to the work station 18 is controlled by a link processor 52. The receiver 16 may act as a central server from which the data signal received by the receiver 16 may be retrieved by a third party. The received data signal may undergo processing at the receiver 16. The third party may retrieve the processed data signal.

According to other embodiments an additional receiver 16 is not necessary. In vivo data received and recorded by the hand-held data recorder 14 is downloaded from the hand-held data recorder directly to the work station 18 for processing and later viewing by a health professional.

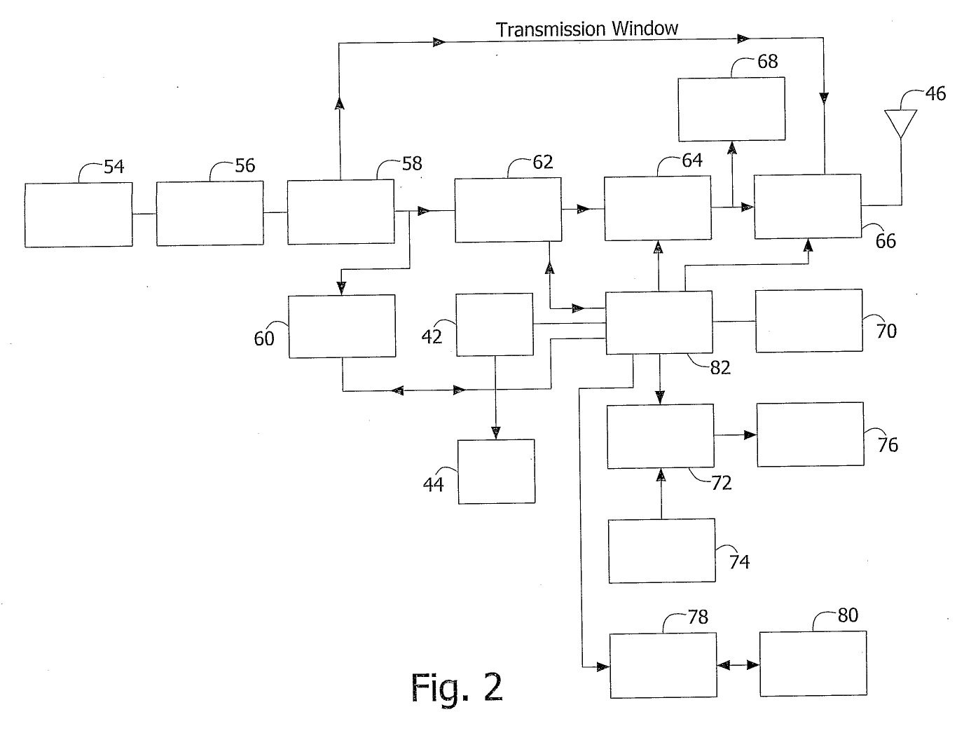

Reference is now made to FIG. 2. The hand-held data recorder 14 may include an antenna unit 54 to which the data recorder receiving antenna 40 may be connected. Connected to the antenna unit 54 is an RF/IF unit 56 followed by a radio frequency (RF) modem transceiver 58. The output of the RF modem transceiver 58 is data bits which may be input to a telemetry storage unit 60 for storing telemetry information in the received data signal. Telemetry information may include this information relating to the status of the in vivo sensing device, the frame capture rate used at a certain period, position information, location information, etc.

The output of the RF modem transceiver 58 may include an indication about possible transmission periods, for example transmission windows in which a radio transmitter can send signals to the in vivo sensing device 12. A transmission window might be used, for example, in cases the in vivo device 12 cannot receive and transmit data simultaneously. A compression/decompression unit 62 may be included for compressing and decompressing the data bits. The compression/decompression unit 62 may have “smart select” capability so that image frames that match certain given criteria may not be compressed and may not be transmitted by the hand-held data recorder 14. In some embodiments, the “smart select” capability may be included in a data recorder processor unit 82. The hand-held data recorder 14 may include a temporary data storage and control unit 64 that contains a memory and associated control logic for temporarily storing a given number of image frames and other data received from the in-vivo sensing device 12 and for controllably interfacing the stored data with other units of the hand-held data recorder 14. In some embodiments, a temporary data storage and control unit may not be required, and/or the data may be transmitted directly to the receiver. The temporary data storage and control unit 64 may be connected to a radio transmitter and control unit 66 integral with the hand-held data recorder 14, that is, an internal unit. Radio transmitter and control unit 66 may transmit data to the in vivo sensing device, and/or may transmit data to a receiver, for example via a data recorder transmitting antenna unit 46. The temporary data storage and control unit 64 may communicate with an interface to an external radio transmitter and control unit 68. For both the internal and external radio transmitters, the radio transmitter may operate as a transmitter for at least any one of the following technologies: cellular transmission, WLAN (Wireless Local Area Network) transmission, BT (BlueTooth) transmission and Wimax (Worldwide interoperability for Microwave Access) transmission.

The hand-held data recorder 14 may have various human machine interface (HMI) functions 70 for controlling the hand-held data recorder 14, including for example interfaces such as keyboards, touch-screens and pushbuttons. A power management unit 72, connected to a power source such as data recorder battery 74, manages and provides power 76 to the units of the hand-held data recorder 14. A USB interface 78 and a USB connector 80 enables data transmission via the cable 50 (which may be connected to USB connector 80, as shown in FIG. 1). A data recorder processor unit 82, connected to the various units as shown in FIG. 2, provides overall control of the hand-held data recorder 14 and provides required processing capability. In some embodiments, data recorder processor unit 82 may include multiple processing units, for example two or more separate processors. Data recorder processor unit 82 may optionally include a DMA (direct memory access) unit, to transfer data to/from the temporary data storage and control unit 64, independently of any of the processors in processor unit 82.

The data received by the hand-held data recorder 14 from the in-vivo sensing device 12 may be transmitted from the hand-held data recorder 14 to the receiver 16 intermittently in batches of image frames and other data during the acquisition period. For example, image frames received by the hand-held data recorder 14 from the in-vivo sensing device 12 may be stored in the temporary data storage unit 64 until a batch of image frames has been received and stored. The batch of temporarily stored image frames may then be transmitted to the receiver 16. The receiver 16 may then transmit the received batch of image frames to the work station 18. In this manner, batches of image frames may be transmitted from the hand-held data recorder 14 to the receiver 16 intermittently, in quasi real time, each time the number of image frames stored in the temporary data storage unit 64 reaches a specified number of image frames constituting the batch. For example, from the beginning of the acquisition period, the image frames received by the hand-held data recorder 14 from the in-vivo sensing device 12 are temporarily stored in the temporary data storage unit 64 until a first batch of N image frames is acquired, where N is a real number (1, 2, 3, 4 . . . ). The first batch of N image frames is then transmitted to the receiver 16. Following this, a second batch of N image frames is received by the hand-held data recorder 14 and temporarily stored in the temporary data storage unit 64 before being transmitted to the receiver 16, and so on until the end of the acquisition period. In this way a batch of N image frames may be transmitted from the hand-held data recorder 14 to the receiver 16 every T minutes, where T is a real positive number.

According to some embodiments, the receiver 16 may receive and store all the image frames received from the hand-held data recorder 14 until the completion of the acquisition period and consequently download the data signal comprising all the image frames to the work station 18.

According to some embodiments, the receiver 16 may download image frames to the work station 18 intermittently in batches of N image frames, or in multiples thereof. For example, image frames received by the receiver 16 from the hand-held data recorder 14 may be temporarily stored until the number of images reaches a given number of image frames defining a batch. Each time the number of image frames stored in the receiver 16 reaches a batch, the batch is downloaded to the work station 18.

According to some embodiments, downloading of received image frames and other data from the receiver 16 to the work station 18 may occur off-line, for example after the receiver 16 has completed receiving and storing the data signal received from the hand-held data recorder 14. That is, receiver 16 may receive and store all the batches of image frames and other data received from the hand-held data recorder 14 during the acquisition period and only download the stored image frames and other data to the work station 18 after all the image frames and other data have been received from the hand-held data recorder 14. According to some embodiments, in-vivo data may be acquired from several patients in succession. The acquired in-vivo data may be stored in the hand-held data recorder 14 until in-vivo sensing of the region of interest of each patient has been completed for all the patients. The data obtained from different patients may be distinguished by entering an identifying indication to the hand-held data recorder 14 prior to performing in-vivo sensing on each patient. The identifying indication may be the name of each patient or an identity number assigned to each patient. The identifying indication may be entered to the hand-held data recorder 14 by means of a keyboard located on the hand-held data recorder 14 or by using the data recorder display unit 42 adapted to be used as a touch-screen for entering data by hand. The identifying indication may be input to the hand-held data recorder 14 by transmitting the information to the hand-held data recorder 14, for example by wireless transmission from receiver 16 or from a workstation. In such embodiments, receiver 16 or the workstation includes a transmitter and a transmitting antenna.

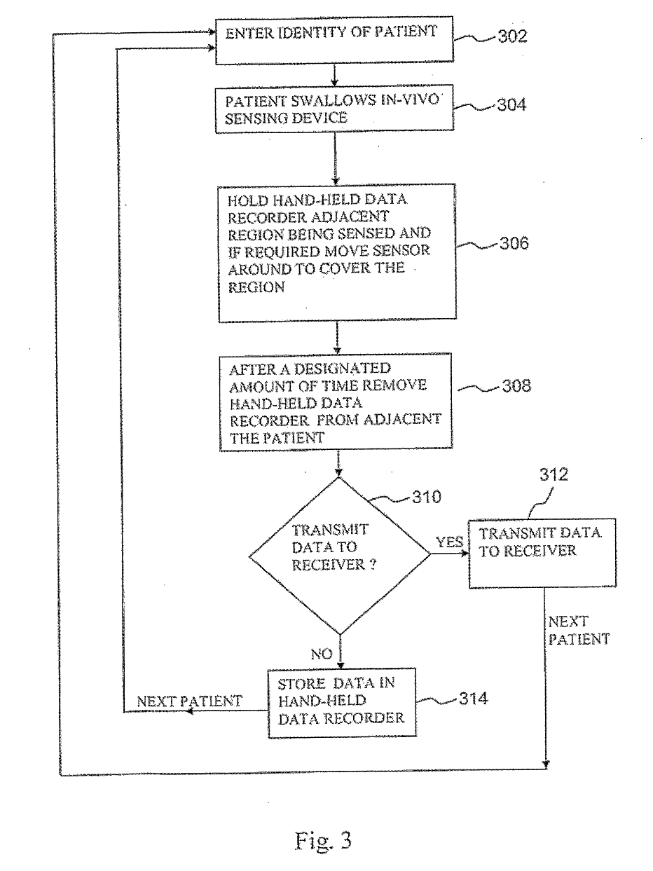

In some embodiments, a procedure of in-vivo sensing of a number of patients one after the other may be performed as illustrated in FIG. 3. An operator may enter or input an identifying indication of a patient (step 302) and activate the in-vivo sensing device 12. In some embodiments, the in-vivo sensing device 12 may have an identifier code internally stored therein and step 302 may be replaced by, or supplemented by, the in-vivo device 12 transmitting the identifier code when it is activated and the hand-held data recorder receiving and storing the identifier code. The patient swallows the in-vivo sensing device 12 (step 304). The operator holds or maintains the hand-held data recorder 14 adjacent a region of interest to be sensed and, if required, the operator may move the hand-held data recorder 14 around, adjacent to the patient's body, to cover the region of interest (step 306). During this time, data in the form of image frames and possible other data, are transmitted by the in-vivo sensing device 12 and received by the hand-held data recorder 14. After a designated amount of time, and/or when the operator decides that the in vivo sensing device completed coverage of the region of interest, and/or when the operator receives an indication from the in vivo sensing device or from the hand-held data recorder 14, the hand-held data recorder 14 is removed from adjacent the patient and the procedure is halted (step 308). The designated amount of time is the time taken for the in-vivo sensing device 12 to traverse the region of interest. In a non-limiting example, if the region of interest is the esophagus then the transit time of the in-vivo sensing device 12 may be less than 5 seconds when patients ingest the in-vivo sensing device 12 with water in the upright position. In such a case, the designated amount of time may be fixed as 5 seconds. The transit time may be lengthened by having the patient ingest the in-vivo sensing device 12 lying horizontally. Hence, other transit times and consequently other designated amounts of time are possible for a given region of interest. Likewise, other transit times and consequently other designated amounts of time are possible for other regions of interest. In some embodiments, the designated amount of time may be determined by the user, based on real-time viewing of the image data sent from the in vivo imaging device. Following step 308 a decision is made as to whether to transmit the received data to the receiver 16 (step 310). According to some embodiments, the data recorded by the hand-held data recorder 14 may be transmitted to the receiver 16 prior to carrying out the procedure on the next patient (step 312). According to some embodiments, the data recorded by the hand-held data recorder 14 remains stored therein (step 314) and the operator may commence with the procedure on the next patient. According to some embodiments, the data received by the receiver 16 may be downloaded to tie work station 18. Typically, the hand-held data recorder need not be reset or initialized between procedures on the same patient or on different patients.

While the present invention has been described with reference to one or more specific embodiments, the description is intended to be illustrative as a whole and is not to be construed as limiting the invention to the embodiments shown. It is appreciated that various modifications may occur to those skilled in the art that, while not specifically shown herein, are nevertheless within the scope of the invention.

1. An in-vivo sensing system comprising an in-vivo sensing device and a data recorder for receiving sensed data transmitted by the in-vivo sensing device wherein the data recorder comprises an internal data recorder receiving antenna.

2. The system according to claim 1, wherein the data recorder comprises a data recorder transmitting antenna.

3. The system according to claim 2 wherein the data recorder further comprises a radio transmitter.

4. The system according to claim 3 wherein the radio transmitter transmits batches of sensed data.

5. The method according to claim 4, wherein the sensed data is transmitted wirelessly by a technology selected from the group consisting of (i) cellular transmission, (ii) WLAN (Wireless Local Area Network) transmission, (iii) BT (BlueTooth) transmission, and (iv) Wimax (Worldwide interoperability for Microwave Access) transmission

6. The system according to claim 1, wherein the data recorder is configured to be hand-held.

7. The system according to claim 1 wherein the data recorder comprises a data recorder display unit.

8. The system according to claim 1 wherein the data recorder comprises a temporary data storage unit.

9. The system according to claim 1 wherein the data recorder comprises a power management unit.

10. A method for operating an in-vivo sensing device comprising the steps of:
(i) providing a data recorder externally to a patient for receiving in vivo data transmitted from an in vivo sensing device within the patient; and
(ii) inputting to the data recorder an identity code of the patient;

11. The method according to claim 10, comprising the further step of:
(iii) maintaining the data recorder external to the patient adjacent a region of interest to be sensed by the in-vivo sensing device;

12. The method according to claim 11, comprising the further steps of:
(iv) inputting to the data recorder an identity code of a next patient; and
(v) repeating steps (ii) to (iii) for the next patient.

13. The method according to claim 12, wherein steps (iv) to (v) are performed without initializing the data recorder.

14. The method according to claim 10, comprising the further step of transmitting the received data from the data recorder to a receiver.

15. The method according to claim 13, wherein the received data is transmitted wirelessly.

16. The method according to claim 13, wherein the received data is transmitted from the data recorder in batches.

17. The method according to claim 10, comprising the further step of transmitting control data from the data recorder to the in-vivo sensing device.

18. The method according to claim 10, wherein the hand-held data recorder contains an internal data recorder transmitting antenna.
